(19) United States
(12) Patent Application Publication
(10) Pub. No.: US 2026/0308938 A1
(43) Pub. Date: Oct. 8, 2026

(54) PADLOCK

(71) Applicant: ASSA ABLOY AB, Stockholm (SE)

(72) Inventor: Tomasz Babiuk, Dziekanowice (PL)

(21) Appl. No.: 19/479,433

(22) PCT Filed: May 3, 2024
(86) PCT No.: PCT/EP2024/062284

§ 371 Date: Oct. 28, 2025

(30) Foreign Application Priority Data
May 19, 2023 (SE) 2350602-5

(51) Int. Cl. E05B 47/00; E05B 67/22

(52) U.S. Cl. CPC E05B 47/0001; E05B 67/22; E05B 2047/0058; E05B 2047/0062

(57) ABSTRACT

A padlock (10) comprising a body (12); a shackle (14); a blocking mechanism (22) arranged to adopt a blocked state (24) and a unblocked state (26) for blocking and unblocking, respectively, the shackle in a locked shackle position; a locking element (28) rotatable for controlling the blocking mechanism; an actuator (38) configured to adopt a locked state (40) for locking the locking element, and an unlocked state (42); an actuating element (48) operatively connected to the locking element and arranged to be manually manipulated to move the locking element when the actuator adopts the unlocked state; an electronic control system (56) arranged to control the actuator; and at least one energy harvesting device (58), each energy harvesting device being arranged to be actuated by a movement of the shackle, the locking element or the actuating element to generate electric energy to the control system (56).

### TECHNICAL FIELD

The present disclosure generally relates to padlocks. In particular, a padlock comprising an energy harvesting device is provided.

### BACKGROUND

Padlocks configured to wirelessly receive electric energy by near-field communication (NFC) from a mobile phone for controlling an actuator are previously known. Such padlocks may comprise a blocking mechanism for blocking the shackle in a locked shackle position, a rotatable locking shaft for controlling the blocking mechanism, and a manually rotatable knob for rotating the locking shaft. By controlling the actuator to engage and to disengage the locking shaft, the padlock can adopt a locked state and an unlocked state, respectively. When the shackle is in the locked shackle position and the actuator adopts the locked state, the padlock is locked.

An operating sequence of a padlock of the above type may comprise two steps for unlocking:
1. Wirelessly transmitting a credential and electric energy via NFC from the mobile phone to the padlock such that the actuator is controlled to disengage from the locking shaft.
2. Manually rotating the knob to rotate the locking shaft to unblock the blocking mechanism.

For locking the padlock, an operating sequence may comprise two steps:
3. Manually rotating the knob to rotate the locking shaft to block the blocking mechanism.
4. Wirelessly transmitting electric energy via NFC from the mobile phone to the padlock such that the actuator is controlled to engage the locking shaft.

### SUMMARY

A capacity of electric energy transmission by NFC from a mobile phone to a padlock is limited. That is, for a relatively short time period, only a relatively small amount of energy can be transmitted to the padlock. Although a higher amount of energy can be transmitted to the padlock during a relatively long time period, such long time period deteriorates a user experience associated with the padlock.

Moreover, such higher amount of energy may only be possible to store in a capacitor for a limited time period. That is, the energy may not be available for controlling the actuator if the padlock has been unlocked for a long time period. In such situation, the user experience is deteriorated if, for example, the user has carried the padlock, but not the mobile phone, to a new location.

One object of the invention is to provide an improved padlock.

The invention is based on the realization that by providing a padlock of the above-described type that additionally comprises an energy harvesting switch arranged to be actuated by a movement of the shackle, by a movement of the locking shaft or by a movement of an actuating element, a step of electrically powering the padlock via NFC for locking the padlock (step 4 above) can be eliminated. User experience is thereby improved.

According to one aspect, there is provided a padlock comprising a body; a shackle manually movable relative to the body between a locked shackle position and an unlocked shackle position; a blocking mechanism arranged to adopt a blocked state and a unblocked state for blocking and unblocking, respectively, the shackle in the locked shackle position; a locking element rotatable relative to the body for controlling the blocking mechanism; an actuator configured to adopt a locked state for locking the locking element, and an unlocked state for unlocking the locking element; an actuating element operatively connected to the locking element and arranged to be manually manipulated to move the locking element when the actuator adopts the unlocked state; an electronic control system arranged to control the actuator; and at least one energy harvesting device, each energy harvesting device being arranged to be actuated by a movement of the shackle, by a movement of the locking element or by a movement of the actuating element to generate electric energy to the control system.

Due to the energy harvesting device, the padlock eliminates a step of needing electric energy to be wirelessly transferred from an external device to the padlock during locking of the padlock, i.e., electric energy for controlling the actuator to switch from the unlocked state to the locked state. The user does therefore not have to carry a mobile phone to accomplish locking of the padlock. Consequently, the user does not need to worry about carrying the mobile phone together with the padlock and situations where the padlock is left open unintentionally are reduced. The padlock therefore provides an improved security considering that a time between unlocking and locking the padlock may sometimes be very long, e.g., several tens of minutes or several hours. Moreover, the control system does not have to store twice the energy needed for one actuation of the actuator.

Since the user will have to move the shackle to the locked shackle position and maneuver the actuating element to bring the blocking mechanism to the blocked state in order to lock the padlock, the padlock can efficiently utilize mechanical energy from one or several of the movements of the shackle, the locking element and the actuating element to produce electric energy needed for the actuator to adopt the locked state. In this way, no step in addition to moving the shackle and moving the actuating element has to be taken to bring the actuator to the locked state. User experience is therefore improved.

The locking element may be rotatable relative to the body between a blocked position and an unblocked position. In these cases, the padlock may be configured such that a rotation of the locking element from the blocked position to the unblocked position causes the blocking mechanism to switch from the blocked state to the unblocked state, and vice versa. The locking element may be rotatable about a locking axis. In comparison with a padlock comprising a motor for rotating the locking element between the blocked and unblocked position, the padlock according to the invention has a design of lower complexity and that is more resilient to bumping.

In order to lock the padlock, the shackle must be in the locked shackle position. The actuating element may then be manually moved to cause the blocking mechanism to adopt the blocked state. The locked and unlocked shackle positions may be a retracted and an extended position, respectively, of the shackle with respect to the body.

In case one energy harvesting device is actuated by a movement of the locking element and/or by a movement of the actuating element, movements of the actuating element (operatively connected to the locking element) by the user can be used both to switch the blocking mechanism and to actuate the associated energy harvesting device. Correspondingly, in case one energy harvesting device is actuated by a movement of the shackle, movements of the shackle by the user can be used both to prepare the padlock for locking and to actuate the associated energy harvesting device. The movement of the shackle may be a movement between the unlocked shackle position and the locked shackle position, such as from the unlocked shackle position to the locked shackle position. Alternatively, the movement of the shackle may be a rotational movement of the shackle about a shackle axis when the shackle is in the unlocked shackle position. The shackle axis may be parallel with, and offset from, the locking axis.

The padlock may comprise only one energy harvesting device, i.e., actuated by movement of any of the shackle, the locking element and the actuating element. Alternatively, the padlock may comprise a plurality of energy harvesting devices, such as one energy harvesting device actuated by a rotation of the locking element, one energy harvesting device actuated by movement of the actuating element, one energy harvesting device actuated by a linear movement of the shackle between the unlocked shackle position and the locked shackle position, and/or one energy harvesting device actuated by a rotation of the shackle in the unlocked shackle position.

The actuating element may be fixed, either directly or indirectly, to the locking element. In some examples, the actuating element and the locking element are integrally formed, e.g., in a single piece of material. When the actuating element is fixed to the locking element, the locking element moves in common with the actuating element. Alternatively, the padlock may comprise a transmission, for example a gear transmission, between the actuating element and the locking element. In any case, the actuating element is operatively connected to the locking element. The actuating element may be configured to be contacted and manipulated by hand of a human user.

In the locked state, the actuator may engage the locking element by direct physical contact therebetween to prevent rotation of the locking element. For example, the actuator may comprise an actuator member received in, and engaging in, a locking recess of the locking element. Alternatively, the locking element may comprise a protruding locking pin that is received in a recess of the actuator member in the locked state of the actuator. In any case, the actuator may be disengaged from the locking element in the unlocked state, e.g., by a physical separation therebetween, to allow rotation of the locking element.

The actuator may be an electromechanical actuator, i.e., an actuator that converts electricity to mechanical actuation. One example of an actuator is a motor that rotates a drive shaft to linearly move an actuating member between two positions in order for the actuator to adopt the locked and unlocked state. A further example of an actuator is a solenoid including an actuating member that moves between two positions in response to power being supplied in order for the actuator to adopt the locked and unlocked state. A further example of an actuator is an arrangement described in WO 2022043112 A1, also referred to as a flip-disc actuator. For the purposes of the present invention, also other types of actuators are conceivable.

The blocking mechanism may for example be a ball mechanism, such as a single ball mechanism or a double-ball mechanism, comprising one or two balls and a driver including a driver recess for each ball. The driver may be fixed to the locking element, such as directly connected thereto or indirectly connected thereto via an intermediate element. In a first rotational position of the driver, each driver recess may be out of alignment with each ball, and the driver may hold each ball in a corresponding shackle recess of the shackle. The blocking mechanism thereby adopts a blocked state. In a second rotational position of the driver, such as angled 90 degrees from the first rotational position, each driver recess may be aligned with each ball, and each ball may thereby be allowed to move out from the associated shackle recess and into the associated driver recess. The blocking mechanism thereby adopts an unblocked state. For the purposes of the present invention, other types of blocking mechanisms are conceivable, for example comprising a driver configured to engage each shackle recess in the blocked state, and configured to disengage from each shackle recess in the unblocked state. In such example, no balls are needed. In further examples, a transmission is provided between the locking element and the driver. In any case, the locking element is configured to control the blocking mechanism, such as to control rotation of a driver thereof.

The control system may be configured to send electric energy, such as an electric pulse, to the actuator to control the actuator. The control system may for example comprise power management electronics, reading electronics and credential evaluation electronics. The power management electronics may be configured to manage the electric energy harvesting by the at least one energy harvesting device and to supply the actuator with power. To this end, the power management electronics may comprise an energy harvesting power supply and a passive non-chemical energy storage, such as a capacitor. The power management electronics may also comprise a power receiver for wirelessly receiving electric power from an external device, such as via NFC.

The reading electronics may comprise a receiving unit, such as an antenna, for wirelessly receiving an input signal, and a reading unit. The reading electronics may be configured to send an access signal to the credential evaluation electronics. The credential evaluation electronics may be configured to determine whether or not authorization should be granted based on the access signal. If access is granted, e.g. if a valid credential is presented, the credential evaluation electronics may issue an electric signal to the actuator.

One, several or all of the blocking mechanism, the locking element, the actuator, the control system and the at least one energy harvesting device may be positioned inside the body. The body may be a housing.

One of the at least one energy harvesting device may be arranged to be actuated by a movement of the shackle from the unlocked shackle position to the locked shackle position.

The at least one energy harvesting device may comprise an energy harvesting switch. The energy harvesting switch may for example be configured to generate less than 1 mJ, such as 0.1 mJ to 0.6 mJ, such as 0.3 mJ to 0.4 mJ, at each triggering thereof. One or a few such triggerings will provide sufficient electric energy to switch the actuator from the unlocked state to the locked state, and vice versa. In case an electric motor would be used to rotate the locking element, such rotation would in some implementations require 20 mJ to 50 mJ, i.e., a substantially higher amount of energy. The energy harvesting switch may be configured to generate the same amount of electric energy for each triggering regardless of the properties of the mechanical force triggering the switch.

When one of the at least one energy harvesting switch is arranged to be actuated by the movement of the shackle, the shackle may or may not contact the energy harvesting switch. Correspondingly, when one of the at least one energy harvesting switch is arranged to be actuated by the movement of the locking element, the locking element may or may not contact the energy harvesting switch. Furthermore, when one of the at least one energy harvesting switch is arranged to be actuated by the movement of the actuating element, the actuating element may or may not contact the energy harvesting switch.

As an alternative to an energy harvesting switch, the at least one energy harvesting device may comprise an electromagnetic generator having a stator and a rotor rotatable relative to the stator. In this case, the at least one energy harvesting device may further comprise a release mechanism for releasing rotation of the rotor. One example of such release mechanism is described in international patent application WO 2019166387 A1, the entire content of which is incorporated herein by reference.

The padlock may comprise at least one tooth provided on the shackle, on the locking element or on the actuating element for actuating the energy harvesting switch.

The energy harvesting switch may be arranged to be actuated multiple times by a single movement of the shackle, of the locking element or of the actuating element in a single direction.

The padlock may comprise a plurality of teeth provided on the shackle, on the locking element or on the actuating element configured to actuate the energy harvesting switch multiple times by a single movement of the shackle, of the locking element or of the actuating element, respectively in a single direction.

The padlock may further comprise an energy storage arranged to store electric energy harvested by the energy harvesting device. The energy storage may comprise a capacitor. According to some examples, the energy storage has a maximum capacity that only suffices to switch the actuator between the unlocked state and the locked state once. In this way, the padlock is better protected against manipulation attacks, e.g., using magnets. As an alternative or as an addition to a capacitor, the energy storage may comprise a battery. In case the energy storage comprises both a capacitor and a battery, the harvested electric energy stored in the capacitor can be used to switch the actuator between the locked state and the unlocked state. If no electric energy from the battery is used for this switching of the actuator, a life of the battery can be increased.

The control system may be configured to wirelessly receive electric energy from an external device. The control system may further be configured to receive and evaluate a credential from the external device.

The locking element may be a locking shaft.

The actuating element may comprise a knob. Alternative types of actuating elements are conceivable.

The actuating element may be rotatable relative to the body. The actuating element may be rotatable about the locking axis or about another axis, such as an axis parallel with, and offset from, the locking axis. In case the actuating element is linearly movable, a transmission between the actuating element and the locking element may be configured to transmit a linear movement of the actuating element to a rotational movement of the locking element.

The actuating element may be positioned on an opposite side of the body with respect to the shackle.

The padlock may be configured such that a movement of the actuating element from an unblocked actuating position to a blocked actuating position causes the blocking mechanism to switch from the unblocked state to the blocked state. In these cases, one of the at least one energy harvesting device may be arranged to be actuated by the movement of the actuating element from the unblocked actuating position to the blocked actuating position, e.g., by being contacted by the locking element operatively connected to the actuating element, or by being contacted by the actuating element. The blocked and unblocked actuating positions may be the same two positions or different two positions for two different opening and closing cycles of the padlock. A single movement of the actuating element may thus be used both to switch the blocking mechanism from the unblocked state to the blocked state, and to actuate an associated energy harvesting device to generate electric energy.

In cases where the actuating element is rotatable, an angular distance between the unblocked actuating position and the blocked actuating position may for example be 30 degrees to 180 degrees, such as 90 degrees. The unblocked and blocked actuating positions of the actuating element may correspond to the unblocked and blocked positions, respectively, of the locking element. That is, when the actuating element is in the unblocked actuating position, the locking element is in the unblocked position, and when the actuating element is in the blocked actuating position, the locking element is in the blocked position. An angular distance between the unblocked position and the blocked position may be the same as, or different from, the angular distance between the unblocked actuating position and the blocked actuating position.

### BRIEF DESCRIPTION OF THE DRAWINGS

Further details, advantages and aspects of the present disclosure will become apparent from the following description taken in conjunction with the drawings, wherein:

FIG. 1: schematically represents a front view of a padlock comprising an energy harvesting device;

FIG. 2: schematically represents an electronic control system of the padlock;

FIG. 3: schematically represents a partial perspective view of the padlock when a blocking mechanism adopts a blocked state;

FIG. 4: schematically represents a partial perspective view of the padlock when the blocking mechanism adopts an unblocked state;

FIG. 5: schematically represents a front view of the padlock when the control system is electrically powered by an external device;

FIG. 6: schematically represents a front view of the padlock when a shackle is in an unlocked shackle position;

FIG. 7: schematically represents a front view of the padlock when the shackle is in a locked shackle position;

FIG. 8: schematically represents a front view of the padlock when an actuating element has been manually manipulated to trigger the energy harvesting device;

FIG. 9: schematically represents a front view of the padlock when an actuator adopts a locked state;

FIG. 10: schematically represents a front view of a padlock according to a further example;

FIG. 11: schematically represents a front view of a padlock according to a further example;

FIG. 12: schematically represents a partial perspective side view of a padlock according to a further example;

FIG. 13: schematically represents a partial perspective top view of a padlock according to a further example; and

FIG. 14: schematically represents a front view of a padlock according to a further example.

### DETAILED DESCRIPTION

In the following, a padlock comprising an energy harvesting device will be described. The same or similar reference numerals will be used to denote the same or similar structural features.

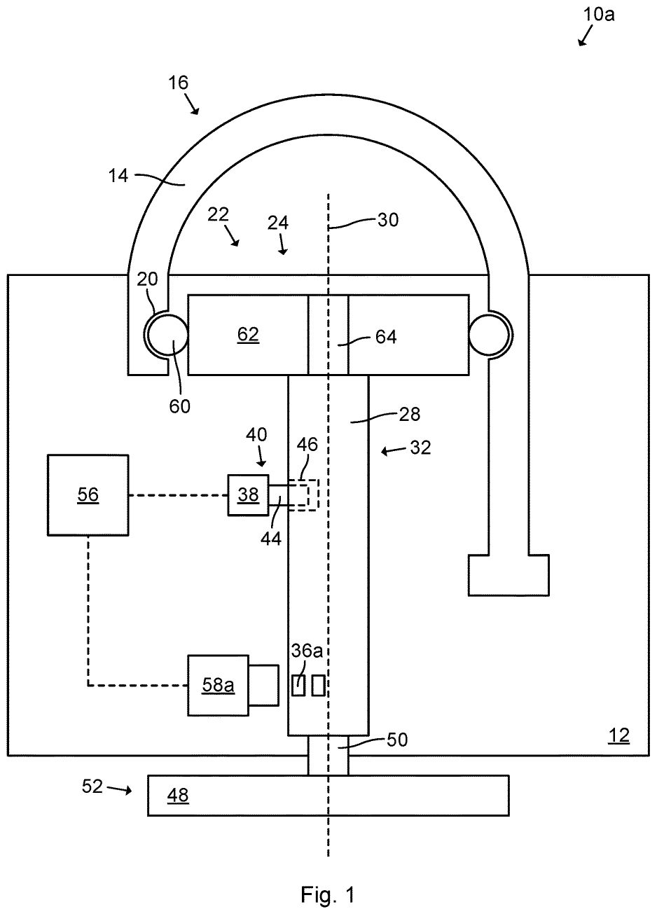

FIG. 1 schematically represents a front view of a padlock 10a. The padlock 10a comprises a body, here exemplified as a housing 12.

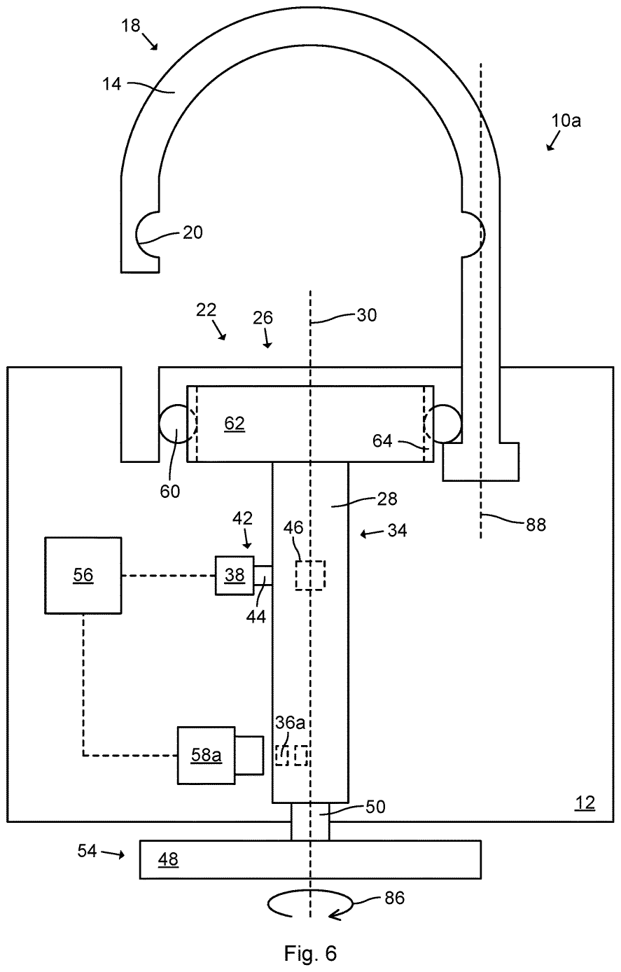

The padlock 10a further comprises a shackle 14. In FIG. 1, the shackle 14 is in a locked shackle position 16. When the padlock 10a is unlocked, the shackle 14 is manually movable relative to the housing 12 between the locked shackle position 16 and an unlocked shackle position 18 (FIG. 6). The shackle 14 of this example comprises two shackle recesses 20. The locked shackle position 16 and the unlocked shackle position 18 are here a retracted and an extended position, respectively of the shackle 14 with respect to the housing 12.

The padlock 10a further comprises a blocking mechanism 22. The blocking mechanism 22 is configured to adopt a blocked state 24 shown in FIG. 1 and an unblocked state 26 (FIG. 4). In the blocked state 24, the blocking mechanism 22 blocks the shackle 14 in the locked shackle position 16 and the shackle 14 is prevented from being lifted. The blocking mechanism 22 is here positioned inside the housing 12.

The padlock 10a further comprises a locking shaft 28. The locking shaft 28 is one example of a locking element according to the present disclosure. The locking shaft 28 is rotatable relative to the housing 12, here about a locking axis 30, between a blocked position 32 shown in FIG. 1 and an unblocked position 34 (FIG. 4). The locking shaft 28 is configured to control the blocking mechanism 22. When the locking shaft 28 is rotated about the locking axis 30 from the blocked position 32 to the unblocked position 34, the blocking mechanism 22 switches from the blocked state 24 to the unblocked state 26, and vice versa. The locking shaft 28 is here positioned inside the housing 12.

The locking shaft 28 of this example further comprises two teeth 36a. In this example, each tooth 36a protrudes radially outwards from the locking shaft 28 with respect to the locking axis 30. The two teeth 36a are axially aligned and angularly displaced with respect to the locking axis 30. The locking shaft 28 in accordance with this example may comprise only one tooth 36a or more than two teeth 36a.

The padlock 10a further comprises an actuator 38. The actuator 38 is configured to adopt a locked state 40 shown in FIG. 1 and an unlocked state 42 (FIG. 4). In the locked state 40, the actuator 38 locks the locking shaft 28 in the blocked position 32. The actuator 38 is here positioned inside the housing 12. The actuator 38 may for example comprise an arrangement as described in international patent application WO 2022043112 A1, the entire content of which is incorporated herein by reference. The actuator 38 of this example comprises an actuator member 44.

The locking shaft 28 of this example further comprises a locking recess 46. In this example, the actuator member 44 is received in the locking recess 46 in the locked state 40 of the actuator 38.

The padlock 10a further comprises a knob 48. The knob 48 is one example of an actuating element according to the present disclosure. The knob 48 of this example is fixed to the locking shaft 28, here via an actuating shaft 50 connected therebetween and passing through the housing 12. The knob 48 is thereby operatively connected to the locking shaft 28.

The knob 48 is positioned outside of the housing 12 and can be contacted by human hand. When the actuator 38 adopts the unlocked state 42, the knob 48 can be rotated to rotate the locking shaft 28 about the locking axis 30. In this example, the knob 48 rotates in common with the locking shaft 28 about the locking axis 30. However, the knob 48 does not necessarily have to rotate in common with the locking shaft 28 and can rotate about another axis or move in other ways, such as linearly. In these cases, a transmission (not shown) may be provided between the knob 48 and the locking shaft 28.

The knob 48 is movable between a blocked actuating position 52 shown in FIG. 1 and an unblocked actuating position 54 (FIG. 6). In this example, the knob 48 can rotate about the locking axis 30 between the blocked actuating position 52 and the unblocked actuating position 54 when the actuator 38 adopts the unlocked state 42. As the knob 48 of this example is fixed to the locking shaft 28, the blocked actuating position 52 of the knob 48 corresponds to the blocked position 32 of the locking shaft 28 and the unblocked actuating position 54 of the knob 48 corresponds to the unblocked position 34 of the locking shaft 28.

The padlock 10a further comprises an electronic control system 56. The control system 56 is arranged to control the actuator 38. The control system 56 is arranged inside the housing 12.

The padlock 10a of this example further comprises an energy harvesting switch 58a. The energy harvesting switch 58a is one example of an energy harvesting device according to the present disclosure. The energy harvesting switch 58a is here arranged inside the housing 12.

The energy harvesting switch 58a of this example is arranged to be contacted by, and triggered by, each tooth 36a during rotation of the locking shaft 28 about the locking axis 30. Each time the energy harvesting switch 58a is triggered by a tooth 36a, the energy harvesting switch 58a generates electric energy, for example 0.3 mJ to 0.4 mJ for each triggering. The electric energy is sent to the control system 56, for example at each triggering. The energy harvesting switch 58a may for example be the switch with model number AFIG-0007 sold by ZF.

The blocking mechanism 22 of this specific and non-limiting example is a double-ball mechanism comprising two balls 60 and a driver 62 including two driver recesses 64 (only one seen in FIG. 1). The driver 62 is here fixed to the locking shaft 28. The locking shaft 28 is positioned between the driver 62 and the knob 48. When the locking shaft 28 is positioned in the blocked position 32, the driver recesses 64 are out of alignment with the balls 60 such that the driver 62 holds the balls 60 in the shackle recesses 20. The blocking mechanism 22 thereby adopts the blocked state 24. The blocking mechanism 22 thereby blocks the shackle 14 in the locked shackle position 16. When the locking shaft 28 is positioned in the unblocked position 34, the driver recesses 64 are aligned with the balls 60 such that each ball 60 can move out from an associated shackle recess 20 and into an associated driver recess 64. The blocking mechanism 22 thereby adopts the unblocked state 26 allowing the shackle 14 to be moved from the locked shackle position 16 to the unlocked shackle position 18.

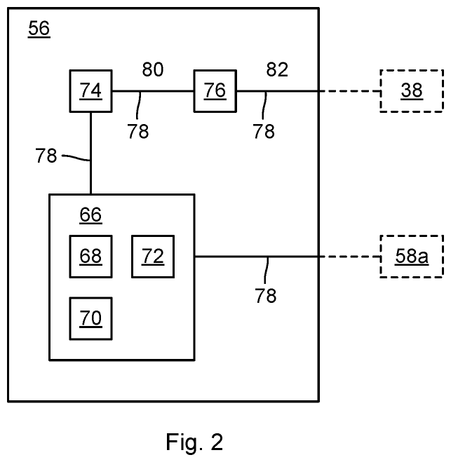

FIG. 2 schematically represents the control system 56 according to one specific and non-limiting example. The control system 56 of this example comprises power management electronics 66. The power management electronics 66 of this example comprises a capacitor 68 constituting one example of an energy storage according to the present disclosure. The power management electronics 66 may further comprise an energy harvesting power supply 70 configured to control the energy harvesting switch 58a. The energy harvesting power supply 70 may for example be constituted by the model LTC® 3588-1 sold by Linear Technology. The power management electronics 66 may further comprise a power receiver 72 for wirelessly receiving electric power from an external device, such as via NFC. A lock comprising such power receiver 72 is for example described in EP 3819878 B1, the entire content of which is incorporated herein by reference. Alternatively, or in addition, the power receiver 72 may for example be the model SIC4310 sold by Silicon Craft, the model NAC1080 sold by Infineon, or any model of the the NTAG family sold by NXP.

The control system 56 of this example further comprises reading electronics 74, credential evaluation electronics 76 and electrical conductors 78, here constituted by electrical cables. One electrical conductor 78 connects the energy harvesting switch 58a to the power management electronics 66, one electrical conductor 78 connects the power management electronics 66 to the reading electronics 74, one electrical conductor 78 connects the reading electronics 74 to the credential evaluation electronics 76, and one electrical conductor 78 connects the credential evaluation electronics 76 to the actuator 38. The actuator 38 is thereby arranged to be electrically powered by the energy harvesting switch 58a.

The reading electronics 74 of this example comprises an antenna (not shown) for receiving an input signal, and a reading unit (not shown). The reading electronics 74 is configured to wirelessly receive a credential from an external device and to send an access signal 80, based on the credential, to the credential evaluation electronics 76.

The credential evaluation electronics 76 is configured to determine whether or not the actuator 38 should be switched from the locked state 40 to the unlocked state 42 based on the access signal 80. If the authorization request is denied, the actuator 38 is not switched, i.e. remains in the unlocked state 42. If the authorization request is granted, e.g. if a valid credential is presented, the credential evaluation electronics 76 issues an electric signal 82 to the actuator 38.

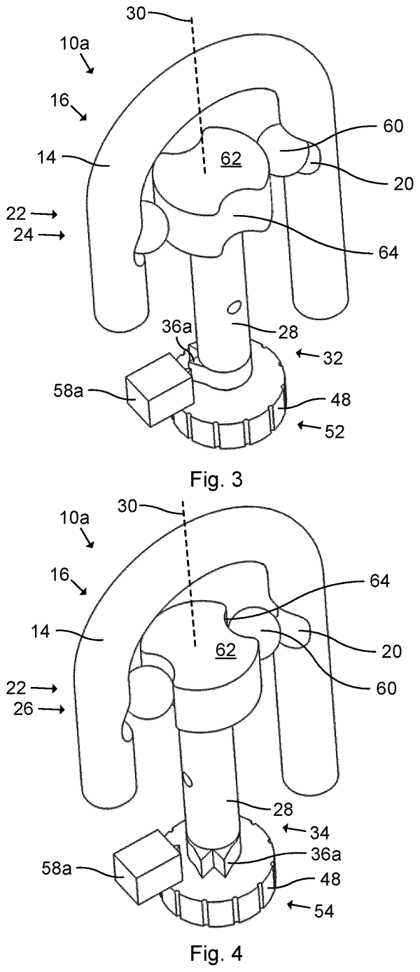

FIG. 3 schematically represents a partial perspective view of the padlock 10a. The shackle 14 in FIG. 3 has a circular cross-sectional profile. In FIG. 3, the shackle 14 is in the locked shackle position 16, the blocking mechanism 22 is in the blocked state 24, the locking shaft 28 is in the blocked position 32 and the knob 48 is in the blocked actuating position 52. FIG. 3 further shows one example of a design of the teeth 36a. As shown, each tooth 36a of this example is V-shaped.

FIG. 4 schematically represents a partial perspective view of the padlock 10a. In FIG. 4, the shackle 14 is in the locked shackle position 16, the blocking mechanism 22 is in the unblocked state 26, the locking shaft 28 is in the unblocked position 34 and the knob 48 is in the unblocked actuating position 54. In this specific and non-limiting example, the locking shaft 28 is rotated 90 degrees about the locking axis 30 between the blocked position 32 and the unblocked position 34.

As the locking shaft 28 rotates between the blocked position 32 and the unblocked position 34, the teeth 36a will be driven to contact the energy harvesting switch 58a one at a time, such that each tooth 36a causes one unique triggering of the energy harvesting switch 58a to cause harvesting of electric energy. The energy harvesting switch 58a can thus be triggered multiple times by a single movement of the locking shaft 28 between the blocked position 32 and the unblocked position 34.

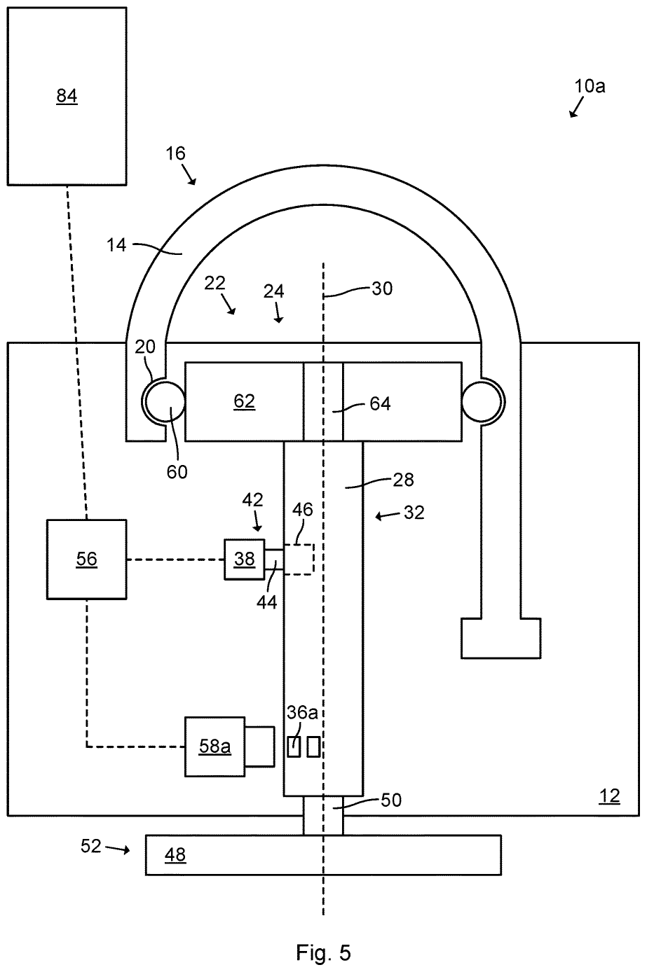

FIG. 5 schematically represents a front view of the padlock 10a. FIG. 5 further shows a mobile phone 84. The mobile phone 84 is one example of an external device according to the present disclosure.

In FIG. 5, the padlock 10a is tapped with the mobile phone 84. Electric energy and a credential are wirelessly sent from the mobile phone 84 to the control system 56. The electric energy may be stored in the capacitor 68. If the credential is valid, the control system 56 sends electric energy to the actuator 38 to control the actuator 38 to switch from the locked state 40 to the unlocked state 42. When the actuator 38 adopts the unlocked state 42, the actuator 38 unlocks the locking shaft 28. In this example, the actuator member 44 is retracted out from the the locking recess 46 in the unlocked state 42 of the actuator 38.

FIG. 6 schematically represents a front view of the padlock 10a. In FIG. 6, the knob 48 has been manually rotated by the user from the blocked actuating position 52 to the unblocked actuating position 54 as shown with arrow 86. As a consequence, the locking shaft 28 is rotated from the blocked position 32 to the unblocked position 34. During this rotation, each tooth 36a triggers the energy harvesting switch 58a to generate electric energy. The rotation of the locking shaft 28 from the blocked position 32 to the unblocked position 34 causes the blocking mechanism 22 to switch from the blocked state 24 to the unblocked state 26. The padlock 10a is now unlocked and the shackle 14 can be retracted. In FIG. 6, the shackle 14 has been lifted from the locked shackle position 16 to the unlocked shackle position 18. In the unlocked shackle position 18, the shackle 14 can optionally be rotated about a shackle axis 88.

In many situations, the shackle 14 may be held in the unlocked shackle position 18 for a relatively long period, such as several hours. During this period, the padlock 10a may become distanced from the mobile phone 84, for example by bringing the padlock 10a to a new location remote from the mobile phone 84, or vice versa. Moreover, during such period, the capacitor 68 may get self-discharged.

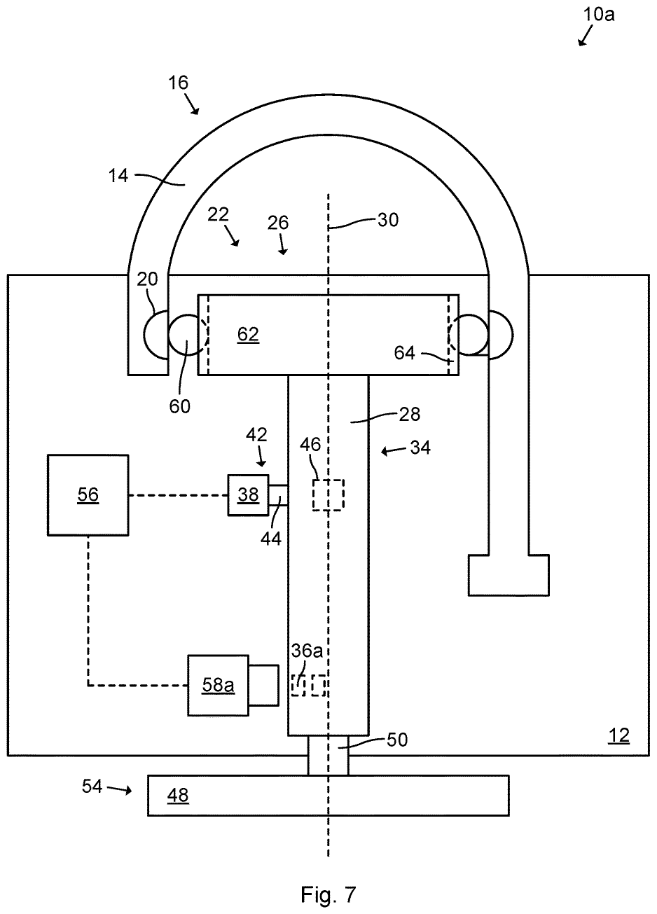

FIG. 7 schematically represents a front view of the padlock 10a when the shackle 14 has been lowered from the unlocked shackle position 18 back to the locked shackle position 16.

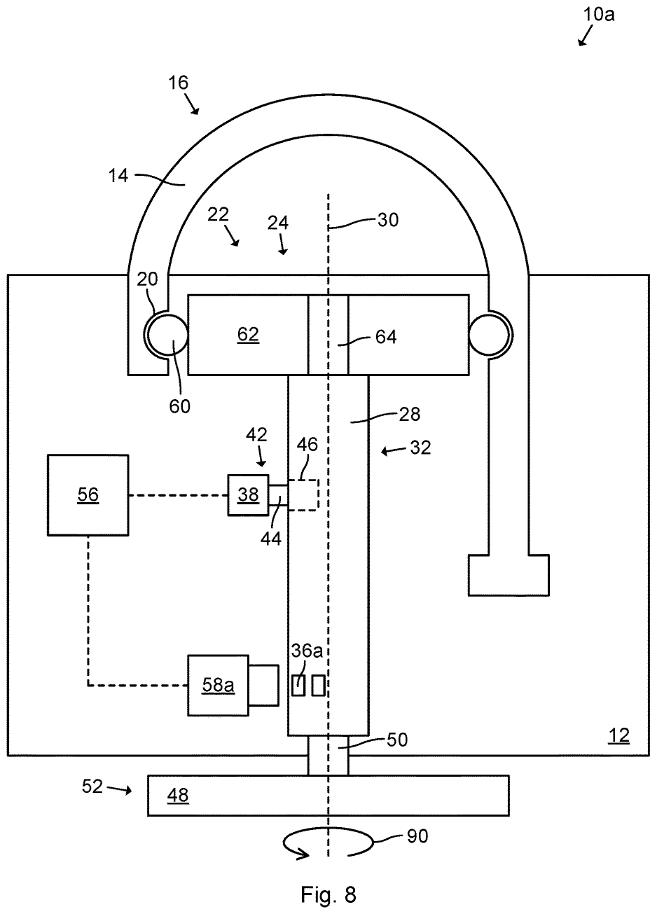

FIG. 8 schematically represents a front view of the padlock 10a. In FIG. 8, the knob 48 has been manually rotated from the unblocked actuating position 54 to the blocked actuating position 52 as shown with arrow 90. The locking shaft 28 has thereby been rotated from the unblocked position 34 to the blocked position 32 causing the energy harvesting switch 58a to be triggered by the teeth 36a to harvest electric energy. The harvested impulse is processed by the control system 56.

In this example, the energy harvesting switch 58a will be triggered twice by this rotation due to the two teeth 36a. The harvested electric energy is stored in the capacitor 68. A step of electrically powering the padlock 10a via NFC for locking the padlock 10a can thereby be eliminated and user experience is improved. This is also of great value since a time in which the shackle 14 is in the unlocked shackle position 18 may be rather long, causing the capacitor 68 to self-discharge. In the padlock 10a of this example, the capacitor 68 may have a maximum capacity that only suffices to switch the actuator 38 between the unlocked state 42 and the locked state 40 once. This makes the padlock 10a more resistant against tampering, for example using a strong magnet. Since the user will anyway have to rotate the knob 48 to cause the blocking mechanism 22 to switch from the unblocked state 26 to the blocked state 24, no additional measure has to be performed to electrically powering the actuator 38.

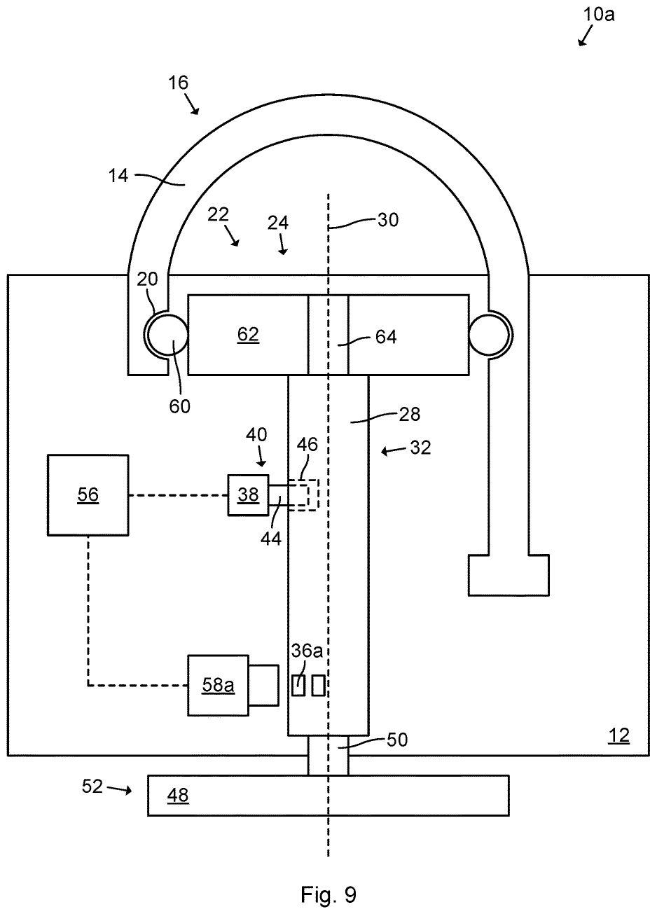

FIG. 9 schematically represents a front view of the padlock 10a. In FIG. 9, the control system 56 has sent electric energy to the actuator 38 to control the actuator 38 to switch from the unlocked state 42 back to the locked state 40 where the actuator 38 locks the locking shaft 28. No credential may have to be evaluated for this purpose. The padlock 10a is thereby locked. In this example, it can be said that mechanical parts of the padlock 10a are responsible for bringing the blocking mechanism 22 to the blocked state 24 while electrical parts of the padlock 10a are responsible for blocking the rotation of the locking shaft 28. The control system 56 may be configured to send an electric pulse in a first direction to the actuator 38 to switch the actuator 38 from the locked state 40 to the unlocked state 42, and to send an electric pulse in a second direction, opposite to the first direction, to the actuator 38 to switch the actuator 38 from the unlocked state 42 to the locked state 40. The control system 56 may be configured to send the electric pulse automatically after detection of certain energy harvesting pattern of the energy harvesting switch 58a.

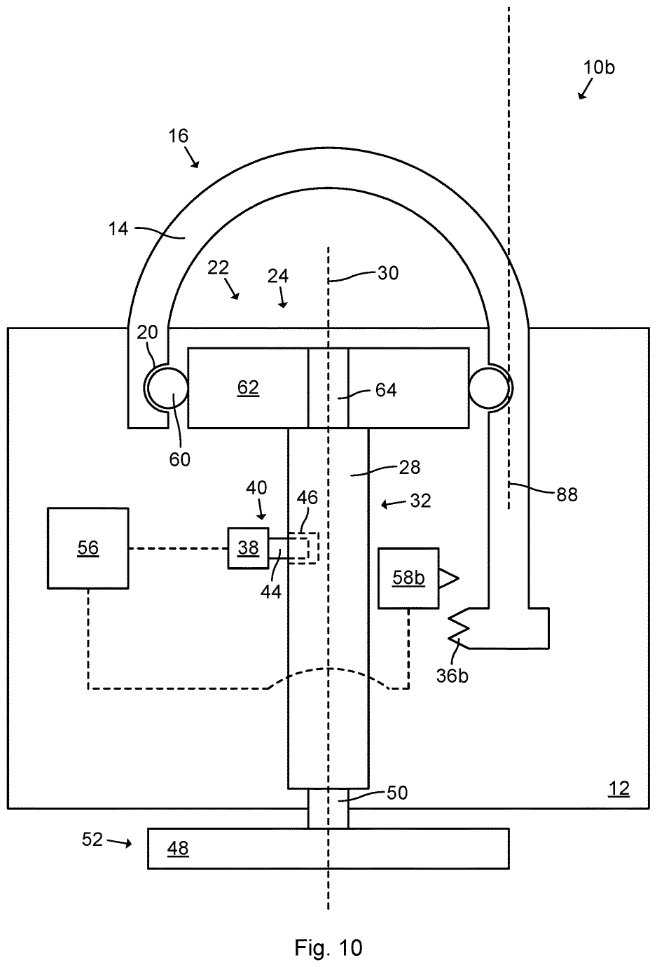

FIG. 10 schematically represents a front view of a padlock 10b according to a further example. Mainly differences with respect to the padlock 10a will be described. Instead of the energy harvesting switch 58a, the padlock 10b comprises an energy harvesting switch 58b. The energy harvesting switch 58b may be of the same type as the energy harvesting switch 58a and configured to generate electric energy to the control system 56.

Instead of the teeth 36a on the locking shaft 28, the padlock 10b of this example comprises two teeth 36b on the shackle 14. Each tooth 36b is configured to contact and trigger the energy harvesting switch 58b during a movement of the shackle 14 between the locked shackle position 16 and the unlocked shackle position 18 to harvest electric energy. The teeth 36b are here aligned in parallel with the shackle axis 88. In the padlock 10b not comprising the energy harvesting switch 58a, a button (not illustrated) may be pushed by a user to effect switching of the actuator 38 after triggering of the energy harvesting switch 58b.

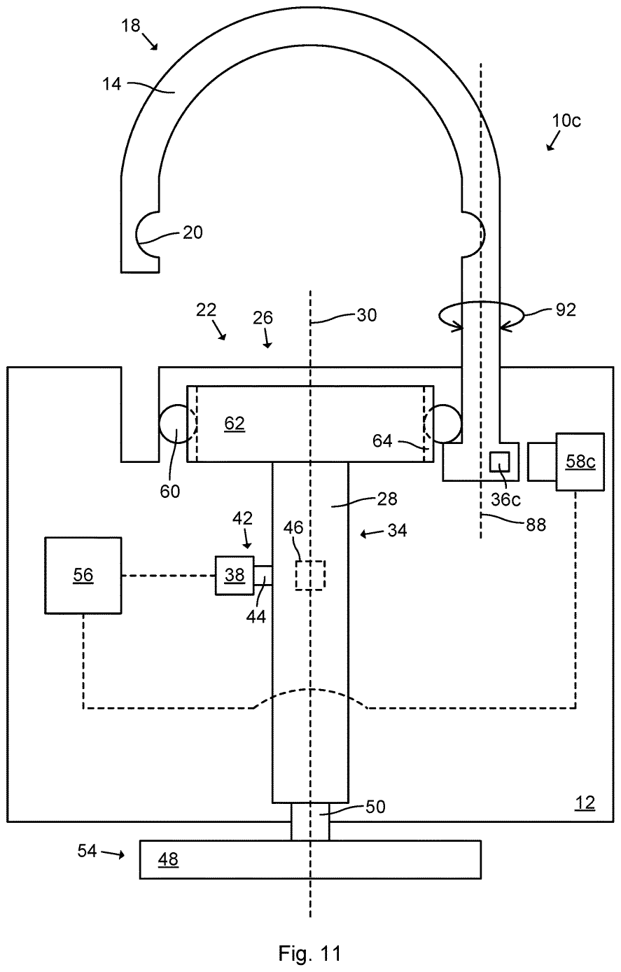

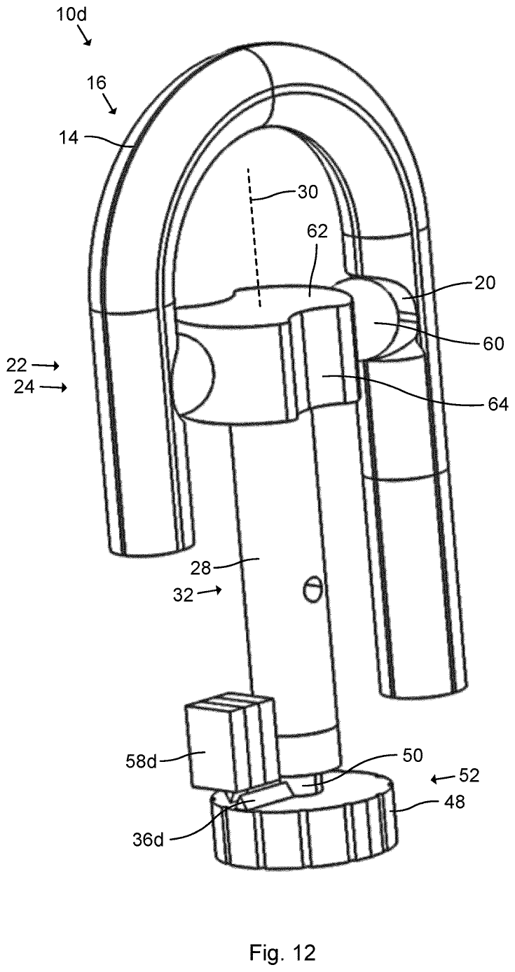

FIG. 11 schematically represents a front view of a padlock 10c according to a further example. Mainly differences with respect to the padlock 10a will be described. Instead of the energy harvesting switch 58a, the padlock 10c comprises an energy harvesting switch 58c. The energy harvesting switch 58c may be of the same type as the energy harvesting switch 58a and configured to generate electric energy to the control system 56.

Instead of the teeth 36a on the locking shaft 28, the padlock 10b of this example comprises one tooth 36c on the shackle 14. The tooth 36c is configured to contact and trigger the energy harvesting switch 58c during a rotation of the shackle 14 about the shackle axis 88, as shown with arrow 92, when the shackle 14 is in the unlocked shackle position 18 to harvest electric energy. The tooth 36c here protrudes radially outwards from the shackle 14 with respect to the shackle axis 88. The shackle 14 may alternatively comprise a plurality of teeth 36c, each for triggering the energy harvesting switch 58c during rotation of the shackle 14. Such plurality of teeth 36c may be angularly displaced around, and axially aligned along, the shackle axis 88. In the padlock 10c not comprising the energy harvesting switch 58a, a button (not illustrated) may be pushed by a user to effect switching of the actuator 38 after triggering of the energy harvesting switch 58c.

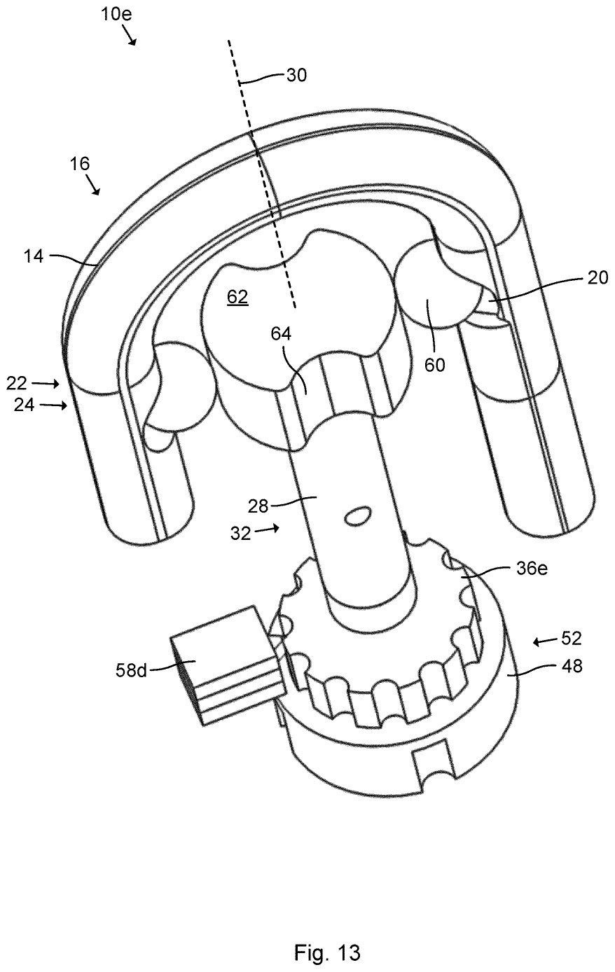

FIG. 12 schematically represents a partial perspective side view of a padlock 10d according to a further example. Mainly differences with respect to the padlock 10a will be described. Instead of the energy harvesting switch 58a, the padlock 10d comprises an energy harvesting switch 58d. The energy harvesting switch 58d may be of the same type as the energy harvesting switch 58d and configured to generate electric energy to the control system 56.

Instead of the teeth 36a on the locking shaft 28, the padlock 10d of this example comprises one tooth 36d on the knob 48. The tooth 36d is configured to contact and trigger the energy harvesting switch 58d during a rotation of the knob 48 between the blocked actuating position 52 and the unblocked actuating position 54 to harvest electric energy. The tooth 36d is here protrudes in parallel with the locking axis 30. The tooth 36d may protrude into the housing 12. Alternatively, the energy harvesting switch 58d may protrude out from the housing 12. Although the padlock 10d of this example comprises only one tooth 36d, the padlock 10d may alternatively comprise a plurality of teeth 36d.

FIG. 13 schematically represents a partial perspective top view of a padlock 10e according to a further example. Mainly differences with respect to the padlock 10d will be described. Instead of the tooth 36d protruding in parallel with the locking axis 30, the padlock 10e of this example comprises a plurality of teeth 36e on the knob 48 protruding radially outwards with respect to the locking axis 30. Each tooth 36e is configured to contact and trigger the energy harvesting switch 58d during a rotation of the knob 48 between the blocked actuating position 52 and the unblocked actuating position 54 to harvest electric energy.

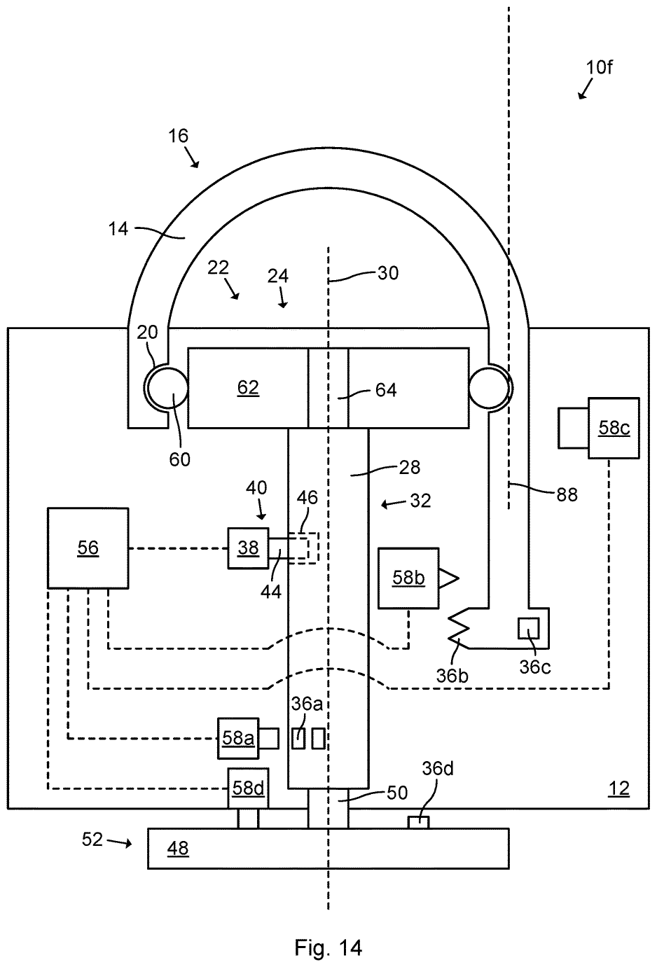

FIG. 14 schematically represents a front view of a padlock 1of according to a further example. Mainly differences with respect to the padlock 10a will be described. The padlock 1of of this example comprises the energy harvesting switch 58a and the teeth 36a for triggering the energy harvesting switch 58a, the energy harvesting switch 58b and the teeth 36b for triggering the energy harvesting switch 58b, the energy harvesting switch 58c and the tooth 36c for triggering the energy harvesting switch 58c, and the energy harvesting switch 58d and the tooth 36d for triggering the energy harvesting switch 58d.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

1. A padlock comprising:
a body
a shackle manually movable relative to the body between a locked shackle position and an unlocked shackle position;
a blocking mechanism arranged to adopt a blocked state and an unblocked state for blocking and unblocking, respectively, the shackle in the locked shackle position
a locking element rotatable relative to the body for controlling the blocking mechanism;
an actuator configured to adopt a locked state for locking the locking element and an unlocked state for unlocking the locking element;
an actuating element operatively connected to the locking element and arranged to be manually manipulated to move the locking element when the actuator adopts the unlocked state;
an electronic control system arranged to control the actuator; and
at least one energy harvesting device;
wherein a movement of the actuating element from an unblocked actuating position to a blocked actuating position causes the blocking mechanism to switch from the unblocked state to the blocked state and wherein each energy harvesting device is arranged to be actuated by at least one of movement of the actuating element from the unblocked actuating position to the blocked actuating position, a movement of the shackle, or by a movement of the locking element.

2. The padlock according to claim 1, wherein one of the at least one energy harvesting device is arranged to be actuated by movement of the shackle from the unlocked shackle position to the locked shackle position.

3. The padlock according to claim 1, wherein the at least one energy harvesting device comprises an energy harvesting switch.

4. The padlock according to claim 3, further comprising at least one tooth provided on the shackle or on the locking element for actuating the energy harvesting switch.

5. The padlock according to claim 3, wherein the energy harvesting switch is arranged to be actuated multiple times by a single movement of the shackle, of the locking element, or of the actuating element in a single direction.

6. The padlock according to claim 3, further comprising a plurality of teeth provided on the shackle, on the locking element, or on the actuating element configured to actuate the energy harvesting switch multiple times by a single movement of the shackle, of the locking element, or of the actuating element, respectively, in a single direction.

7. The padlock according to claim 1, further comprising an energy storage arranged to store electric energy harvested by the energy harvesting device.

8. The padlock according to claim 1, wherein the electronic control system is configured to wirelessly receive electric energy from an external device.

9. The padlock according to claim 1, wherein the locking element is a locking shaft.

10. The padlock according to any of the preceding claim 1, wherein the actuating element comprises a knob.

11. The padlock according to claim 1, wherein the actuating element is rotatable relative to the body

12. The padlock according to claim 1, wherein the actuating element is positioned on an opposite side of the body with respect to the shackle.
